(19) United States
(12) Patent Application Publication
(10) Pub. No.: US 2009/0262292 A1
(43) Pub. Date: Oct. 22, 2009

(54) Electrical connectors between electronic devices

(75) Inventor: Ming-Chin Lee, Hsinchu (TW)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 12/148,201

(22) Filed: Apr. 16, 2008

(51) Int. Cl. G02F 1/1345

(52) U.S. Cl. 349/149

(57) ABSTRACT

A display panel has a plurality of drivers ICs electrically connected to the pixel area. The electrical conductors that are used to electrically connect the driver ICs to the pixel area are arranged in one or more fan-out patterns. The fan-out pattern of at least one of the ICs is arranged such that the slope of all fan-out segments is of the same sign. If the slope of the fan-out segments of that IC is negative, then, for the adjacent IC to the right, the conductor pattern is arranged such that the slope of the leftmost of the fan-out segment of that adjacent IC should also be negative. When three ICs are connected to a common pixel area, the conductor pattern for the middle IC is arranged such that the slope of the leftmost fan-out segment is positive and the slope of the rightmost segment is negative.

### FIELD OF THE INVENTION

The present invention relates generally to a set of electrical conductors between two electronic devices and, more particularly, to the electrical connectors between a drive IC and the pixel area of a display panel.

### BACKGROUND OF THE INVENTION

A display panel, such as a liquid crystal display (LCD) panel comprises a pixel area, a plurality of data lines and gate lines connected to the pixel area. These data lines and gate lines are connected to a plurality of integrated circuit drivers, or driver ICs, as shown in FIG. 1. Each of the driver IC typically has a bond pad area having a plurality of electrically conductive pads (not shown) to allow a plurality of electrical conductors to be connected to the connectors in the pixel area, as shown in FIG. 2. Because the spacing, S_{I}, between adjacent conductors at the IC side is much smaller than the spacing, S_{P}, between adjacent connectors at the pixel area, a fan-out pattern is used to spread out the conductors from the IC side to the pixel area.

As shown in FIG. 2, most of the electrical conductor has three connecting segments: display-side segment ab, fan-out segment bc and IC-side segment cd. In this fan-out pattern, the side conductors are always longer than the conductors in the middle portion of the pattern. For example, conductor A is shorter than conductor B, which is shorter than conductor C, and so on. If the conductors are made of the same material and have substantially the same thickness and width, then a longer conductor has more electrical resistance than a shorter one. In order to reduce the differences in electrical resistance among the conductors in a fan-out pattern, different zigzag path patterns are used to increase the conductor length between two points, as shown in FIGS. 3a to 3c.

As shown in FIG. 3b, the fan-out segment bc is not a straight-line, but its general slope can be determined by the straight-line joining point b to point c. In prior art, the slope of a fan-out segment on the left-side of the fan-out pattern is positive and the slope of a fan-out segment on the right-side of the fan-out segment is negative. For example, the sign of the slope of the fan-out segment in each of the conductors B, C, D, E as shown in FIG. 2 is positive and the sign of the slope of the fan-out segment of each of the conductors B′, C′, D′ and E′ is negative. Moreover, the overall conductor pattern is symmetrical such that shape of the conductor E and the shape of the conductor E′ is substantially the same except that the slope of the fan-out segment of the conductor E and the slope of the fan-out segment of the conductor E′ are opposite in sign.

Accordingly, in a display panel where more than two ICs are electrically connected to the pixel area, the slope of the fan-out segment of the outermost conductor of an IC and the slope of the fan-out segment of the adjacent outermost conductor of the adjacent IC are of different signs. For example, in FIG. 1, the slope of the fan-out segment of the rightmost conductor connecting Data driver IC1 to the pixel area is negative, whereas the slope of the fan-out segment of the leftmost conductor connecting Data driver IC2 to the pixel area is positive.

### SUMMARY OF THE INVENTION

The present invention provides a different connector pattern for use in an electronic module where two or more electronic devices with a narrower connector spacing are connected to another-electron device with a wider connector spacing. The electronic module can be a display panel, for example. In a display panel, the electronic devices with the narrower connector spacing are the driver ICs and the electronic device with the wider connector spacing is the pixel area, as shown in FIG. 1. In particular, the present invention is concerned with the connector pattern of one of two adjacent electronic devices.

The fan-out pattern of at least one of the ICs, according to one embodiment of the present invention, is arranged such that the slope of all fan-out segments is of the same sign. More specifically, if the slope of the fan-out segments of that IC is negative, then, for the adjacent IC to the right, the conductor pattern should be arranged such that the slope of the leftmost of the fan-out segment of that adjacent IC should also be negative. When three ICs are connected to a common pixel area, it is advantageous that the conductor pattern for the middle IC is arranged such that the slope of the leftmost fan-out segment is positive and the slope of the rightmost segment is negative. In the conductor pattern for the IC to the left, the slope of all fan-out segments is positive, whereas the slope of all fan-out segments in the conductor pattern for the IC to the right is negative. The present invention is applicable when the conductor pattern has only one fan-out section, as well as when the conductor pattern has two or more fan-out sections. In that case, at least the slope of the fan-out segments in one of the fan-out section near the pixel side is of the same sign.

Thus, the first aspect of the present invention is an electronic module wherein two or more electronic devices with a narrow connector spacing are connected to another electronic device with a wider connector spacing.

The second aspect of the present invention is a method for use in an electronic module comprising a first electronic device, a second electronic device and a third electronic device, wherein the first electronic device is electrically connected to the third electronic device via a first conductor pattern, the first conductor pattern comprising a first fan-out section, and the second electronic device is electrically connected to the third electronic device via a second conductor pattern.

The third aspect of the present invention is an electrical connector, which comprises:

a first conductor pattern arranged for electrically connecting a first electronic device to a third electronic device, the first conductor pattern having a first side and an opposing second side, wherein the first conductor pattern comprises a first fan-out segment having a narrower end adjacent to the first electronic device and a broader end adjacent to the third electronic device, and the first fan-out segment comprises a first outermost segment on the first side and a second outermost segment on the second side, and wherein the first outermost segment has a first slope sign and the second outermost segment has second slope sign opposite to the first slope sign; and

a second conductor pattern arranged for electrically connecting a second electronic device to the third electronic device, wherein the second conductor pattern has a first side and an opposing second side, the second side of the second conductor pattern adjacent to the first side of the first conductor pattern, and wherein the second conductor pattern comprises a second fan-out segment having a narrower end adjacent to the second electronic device and a broader end adjacent to the third electronic device, and the second fan-out segment comprises a third outermost segment adjacent to the second outermost segment, the third outermost segment having a slope sign which is same as the first slope sign, and wherein the second fan-out segment further comprises a fourth outermost segment spaced from the third outermost segment further from the second outermost segment, the fourth outermost segment having a slope sign which is also same as the first slope sign.

The present invention will become apparent upon reading the description taken in conjunction with FIGS. 3a to 13.

### BRIEF DESCRIPTION OF THE DRAWINGS

FIG. 1 shows a plurality of data driver ICs and gate driver ICs electrically connected to the data and gate lines of a pixel area in a prior art display panel.

FIG. 2 shows a prior art fan-out pattern for use in the electrical conductors connecting the bond pad area of a driver IC and at least a section of the pixel area.

FIG. 3a shows a typical zigzag or folding pattern in an IC-side conductor segment.

FIG. 3b shows a typical zigzag or folding pattern in a fan-out conductor segment.

FIG. 3c shows a typical zigzag or folding pattern in a display-side conductor segment.

FIG. 4 shows a prior art conductor pattern having two fan-out sections.

FIG. 5 shows a conductor pattern, according to one embodiment of the present invention.

FIG. 6 shows the spatial relationship between two ICs wherein one of the ICs has the conductor pattern of FIG. 5.

FIG. 7 shows the spatial relationship between other two ICs wherein one of the ICs has the connector pattern of FIG. 5.

FIG. 8 shows the spatial relationship among three ICs wherein one of the ICs has the conductor pattern of FIG. 5 and another one of the ICs has a reverse connector pattern.

FIG. 9 shows a conductor pattern with two fan-out sections, according another embodiment of the present invention.

FIG. 10 shows the spatial relationship between two ICs wherein one of the ICs has the conductor pattern of FIG. 9.

FIG. 11 shows the conductor patterns of two adjacent ICs, according to a different embodiment of the present invention.

FIG. 12 shows the conductor patterns of two adjacent ICs, according to yet another embodiment of the present invention.

FIG. 13 shows a generalized electronic module having two electronic devices with narrower spacing connected to a third electronic device.

### DETAILED DESCRIPTION OF THE INVENTION

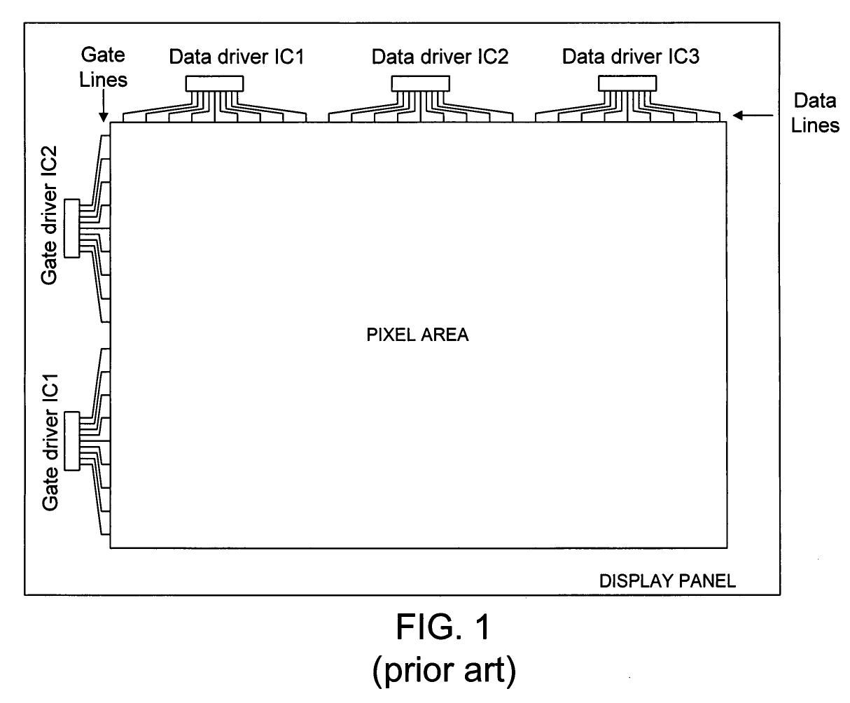

The present invention is concerned with a conductor pattern for use in electrically connecting two or more electronic devices with a narrower connector spacing to another electronic device with a wider connector spacing. For example, the electronic devices with the narrow connector spacing are driver integrated circuits (ICs) and the electronic device with the wider connector spacing is the pixel area of a display panel. In particular, the driver ICs are adjacent to each other and are electrically connected to the same connector of the pixel area. These driver ICs are the three Data driver ICs which are connected to the data lines of the pixel area as shown in FIG. 1, for example.

The present invention is particularly concerned with the fan-out conductor section for use in one of the adjacent ICs. A fan-out section has a plurality of fan-out conductor segments. In prior art, the slope of the left fan-out segments and the slope of the right fan-out segments are opposite in sign. For example, the slope of the left fan-out segments is positive, wherein the slope of the right fan-out segments is negative. In contrast, according to one embodiment of the present invention, the slope of all fan-out segments of a conductor pattern for use in one of the ICs is either positive or negative, depending on the spatial relationship with the adjacent conductor pattern.

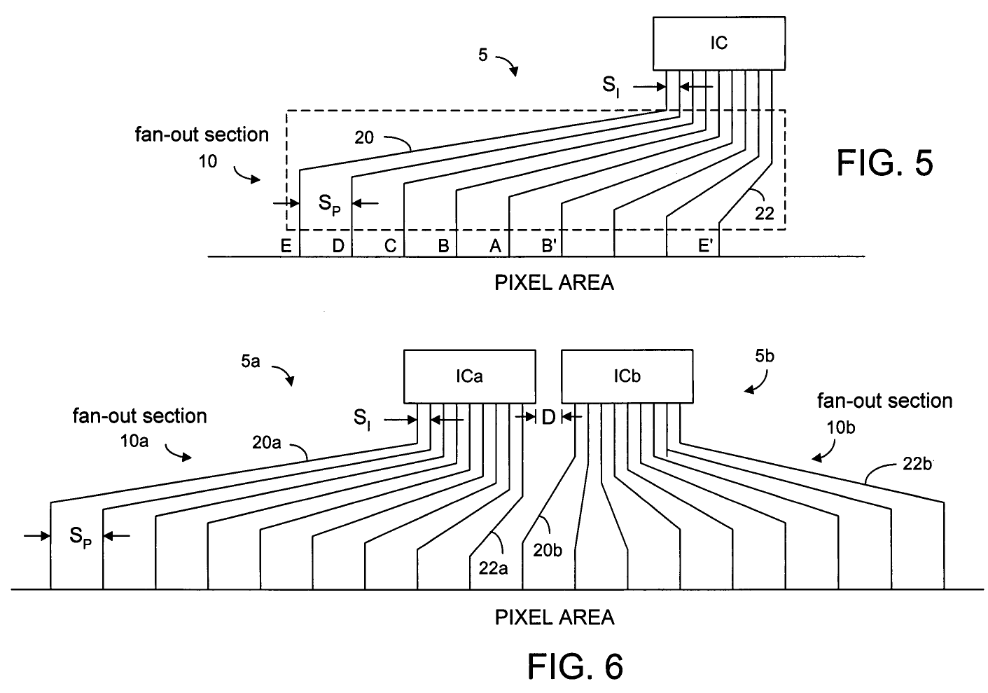

As shown in FIG. 5, the conductor pattern 5 of the electrical conductors connecting the IC to the pixel area has a fan-out section 10. Each of the conductors A, B, . . . , E, E′ has a fan-out segment in the fan-out section 10. For example, the leftmost conductor E has a fan-out section 20, and the rightmost conductor E′ has a fan-out segment 22. The slope of all fan-out sections is positive. As shown in FIG. 5, the slope of the fan-out segment 20 is smaller than the slope of the fan-out segment 22. However, all fan-out segments can have the same slope. It is also possible that the slope of the leftmost fan-out segment 20 is greater than the slope of the fan-out segment 22.

The advantage of having the slope of all fan-out segments is either positive or negative can be seen in FIG. 6. As shown in FIG. 6, when ICa and ICb are both connected to the same connector in the pixel area, the conductor pattern 5a for ICa is arranged such that the slope of all fan-out segments in the fan-out section 10a, including the leftmost segment 20a and the rightmost segment 22a, is positive. In the conductor pattern 5b for ICb, the slope of the leftmost fan-out segment 20b in the fan-out section 10b is positive, but the slope of rightmost fan-out segment 22a is negative. Thus, the conductor pattern 5a of the electrical conductors connecting ICa to the pixel area is different from the conductor pattern 5b of the electrical conductors connecting ICb to the pixel area. As shown in FIG. 6, the slope of the rightmost fan-out segment 22a of the fan-out section 10a for ICa and the slope of the leftmost fan-out segment 20b of the fan-out section 10b for ICb are both positive, or of the same sign. As such, ICa and ICb can be placed very closed to each other, or the distance D is shortened considerably (see FIG. 1 for comparison). The slope of the fan-out segment 22a can be greater or smaller than, or equal to the slope of the fan-out segment 20b. In some cases, it is preferred that the slope of these adjacent two fan-out segments be the same.

Placing two ICs closed to each other has many advantages. For example, if both ICs are fabricated on a same patch of amorphous silicon, the patch can be made smaller. Also, if both ICs share some common voltage sources or a common ground, the connections between the two ICs can be made shorter.

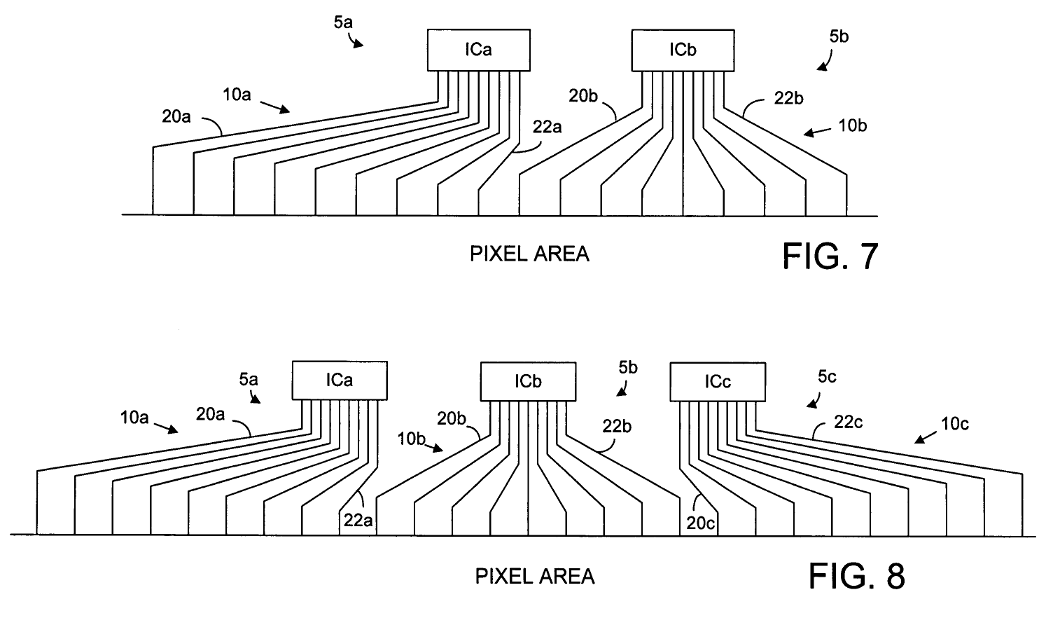

In FIG. 6, the conductor pattern 5b is asymmetrical in that the slope of the leftmost fan-out segment 20b is different from the slope of the rightmost fan-out segment 22b not only on the slope sign, but also on the inclination. However, the conductor pattern 5b can be symmetrical, as shown in FIG. 7.

As shown in FIG. 8, three ICs are connected to a common pixel area. In this case, it is advantageous to arrange the conductor pattern 5c connecting ICc to the pixel area such that it is a reverse pattern of the conductor pattern 5a. In the conductor pattern 5c, the slope of all fan-out segments, including the leftmost segment 20c and the rightmost segment 22c, is negative. As such, the slope of the adjacent segments 22b and 20c is of the same sign. When the conductor patterns 5a and 5c are mirror images of each other and the conductor pattern 5b is symmetrical, the distance between ICa and ICb is substantially the same as the distance between ICb and ICc. Overall, the distance between ICa and ICb is much smaller than that between IC1 and IC2 as shown in FIG. 1.

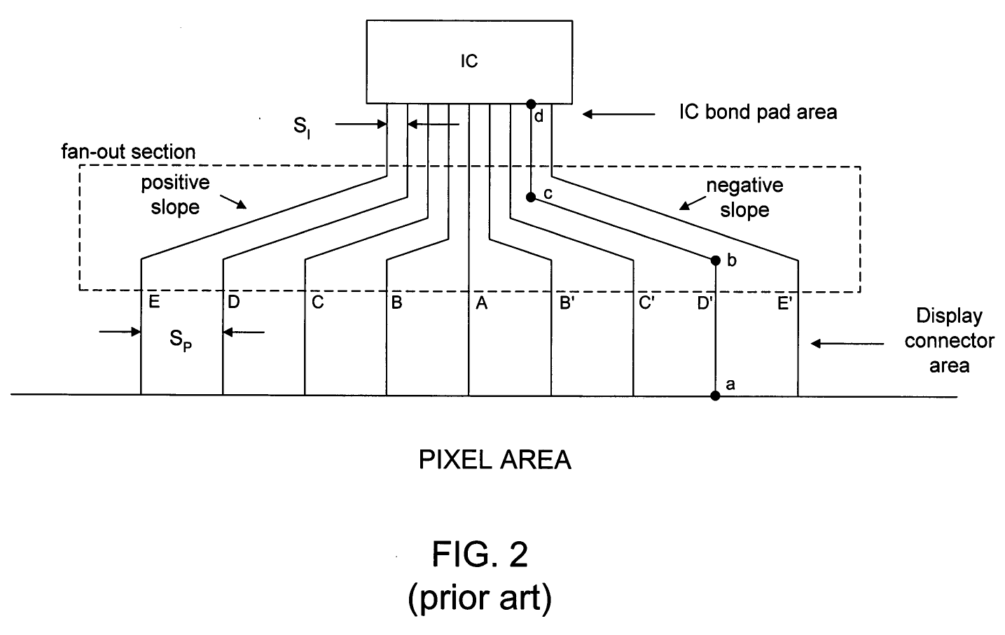

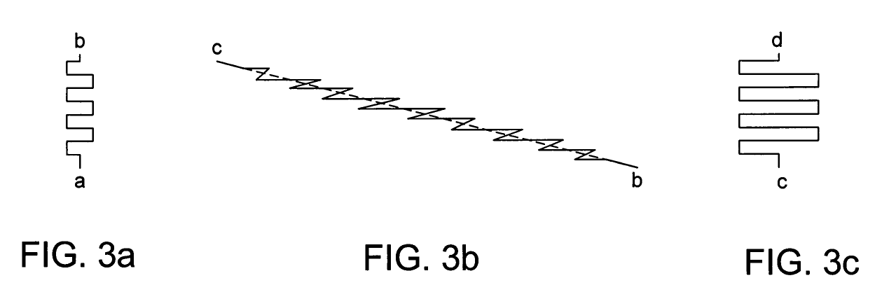

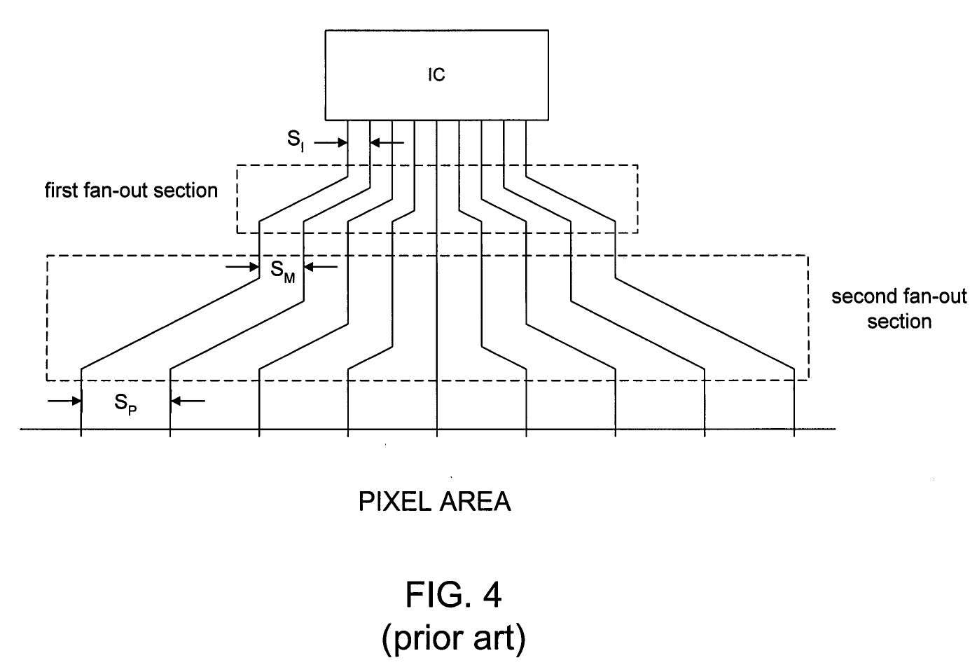

In a conductor pattern that has two fan-out sections, it is also possible to shorten the distance between two adjacent ICs. A typical conductor pattern having two fan-out sections is shown in FIG. 4. As shown in FIG. 4, the first fan-out section widens the spacing S_{I} between adjacent conductors at the IC side to an intermediate spacing S_{M} and the second fan-out section widens the intermediate spacing S_{M} to the spacing S_{P} at the pixel area side. As with the conductor pattern as shown in FIG. 2, the slope of the left fan-out segments is positive, whereas the slope of the right fan-out segments is negative.

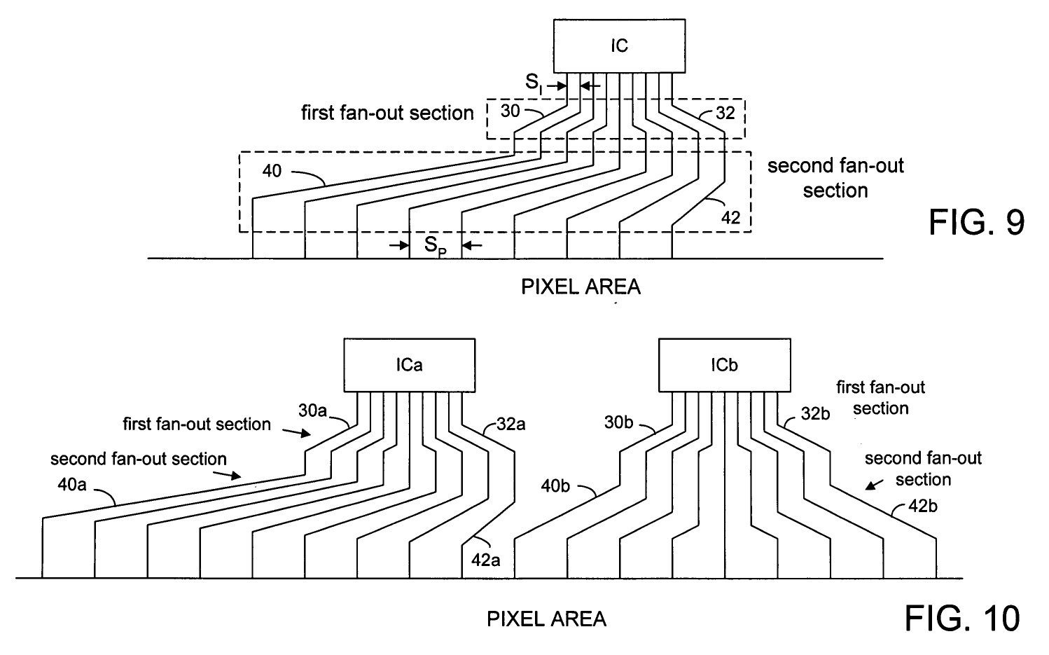

According to another embodiment of the present invention, the slope of all second fan-out segments (the fan-out segments near pixel area side) can be of the same sign, as shown in FIG. 9. As shown in FIG. 9, the slope of the leftmost fan-out segment 30 and the slope of the rightmost fan-out segment 32 in the first fan-out section are of opposite signs, whereas the slope of the leftmost fan-out segment 40 and the slope of the rightmost fan-out segment 42 in the second fan-out section are of the same sign. As such, when two or more ICs are connected to the same pixel area, as shown in FIG. 10, the distance between the two ICs can be shortened. As shown in FIG. 10, when ICa and ICb are both connected to the same connector in the pixel area, the slope of all fan-out segments in the second fan-out section, including the leftmost segment 40a and the rightmost segment 42a, is positive. In the second fan-out section of the conductor pattern for ICb, the slope of the leftmost fan-out segment 40b is positive, but the slope of rightmost fan-out segment 42a is negative. As such, the slope of the rightmost fan-out segment 42a of the second fan-out section for ICa and the slope of the leftmost fan-out segment 40b of the second fan-out section for ICb are both positive, or of the same sign. The slope of the fan-out segment 42a can be greater or smaller than, or equal to the slope of the fan-out segment 40b. In some cases, it is preferred that the slope of these adjacent two fan-out segments be the same.

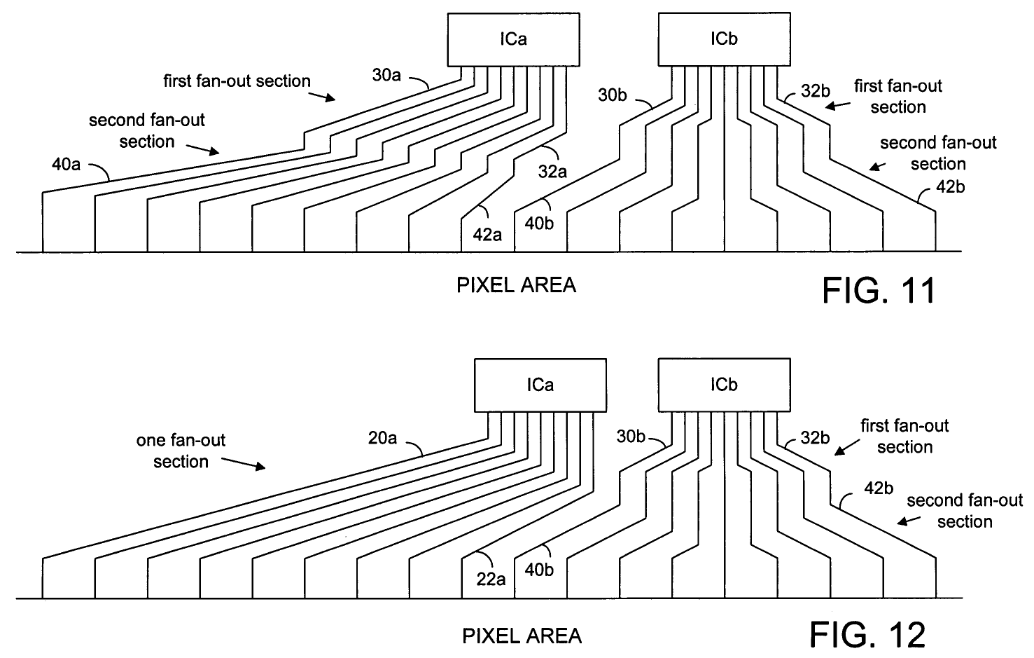

In a different embodiment of the present invention, the slope of all fan-out segments, including the leftmost fan-out segment 30a and the rightmost fan-out segment 32a, in the first fan-out section is of the same sign, as shown in FIG. 11. Furthermore, the slope of the fan-out segments in the first fan-out section and the slope of the fan-out segments in the second fan-out segment are of the same sign.

In yet another embodiment of the present invention, the conductor pattern for ICa has only one fan-out section, whereas the conductor pattern for ICb has two fan-out sections. As shown in FIG. 12, the slope of the fan-out segments, including the leftmost fan-out segment 20a and the rightmost fan-out segment 22a, in the conductor pattern for ICa, and the slope of the leftmost fan-out segment 40b in the second fan-out section in the conductor pattern for ICb are of the same sign. All those slopes are negative slopes.

In sum, in a display panel comprising a plurality of drivers ICs are electrically connected to the pixel area, the electrical conductors that are used to electrically connect the driver ICs to the pixel area are arranged in one or more fan-out patterns. The fan-out pattern of at least one of the ICs, according to one embodiment of the present invention, is arranged such that the slope of all fan-out segments is of the same sign, as shown in FIG. 5. More specifically, if the slope of the fan-out segments of that IC is negative, then, for the adjacent IC to the right, the conductor pattern should be arranged such that the slope of the leftmost of the fan-out segment of that adjacent IC should also be negative, as shown in FIGS. 6 and 7. When three ICs are connected to a common pixel area, it is advantageous that the conductor pattern for the middle IC is arranged such that the slope of the leftmost fan-out segment is positive and the slope of the rightmost segment is negative, as shown in FIG. 8. In the conductor pattern for the IC to the left, the slope of all fan-out segments is positive, whereas the slope of all fan-out segments in the conductor pattern for the IC to the right is negative. The present invention is applicable when the conductor pattern has only one fan-out section, as well as when the conductor pattern has two or more fan-out sections. In that case, at least the slope of the fan-out segments in one of the fan-out section near the pixel side is of the same sign, as shown in FIGS. 10 and 11.

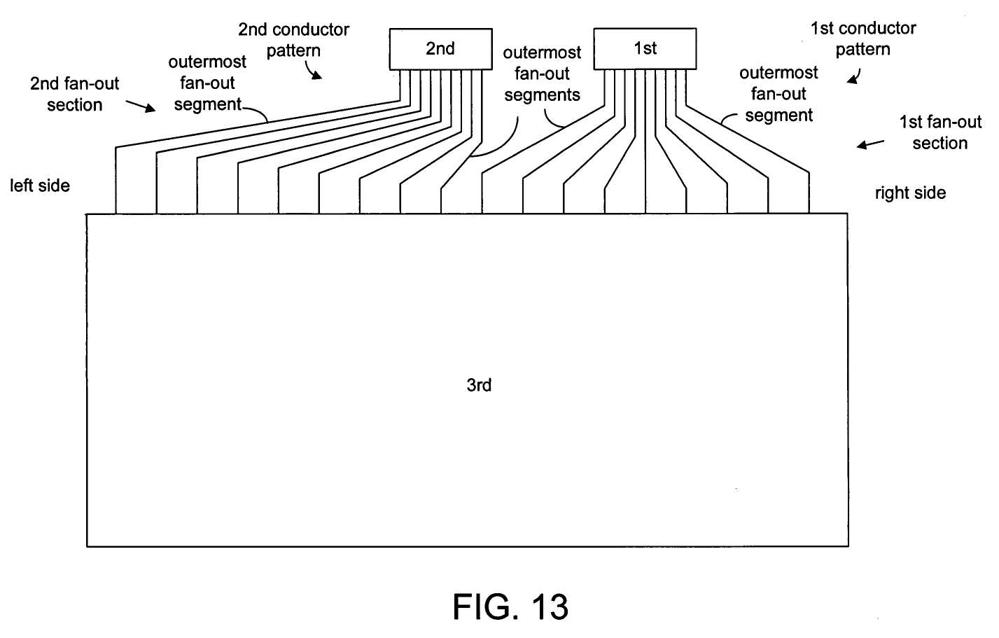

The present invention has been disclosed in connection with the use of integrated circuits and the pixel area in a display panel. It should be understood by a person skilled in the art that the same invention is applicable in an electronic module where two or more electronic devices with a narrow connector spacing are connected to another electronic device with a wider connector spacing. For example, in the electronic module as shown FIG. 13, a first electronic device and a second electronic device with a narrow connector spacing are connected to a third electronic device. The electronic module further comprises:

a first conductor pattern arranged for electrically connecting a first electronic device to a third electronic device, the first conductor pattern having a first side and an opposing second side, wherein the first conductor pattern comprises a first fan-out segment having a narrower end adjacent to the first electronic device and a broader end adjacent to the third electronic device, and the first fan-out segment comprises a first outermost segment on the first side and a second outermost segment on the second side, and wherein the first outermost segment has a first slope sign and the second outermost segment has second slope sign opposite to the first slope sign; and

a second conductor pattern arranged for electrically connecting a second electronic device to the third electronic device, wherein the second conductor pattern has a first side and an opposing second side, the second side of the second conductor pattern adjacent to the first side of the first conductor pattern, and wherein the second conductor pattern comprises a second fan-out segment having a narrower end adjacent to the second electronic device and a broader end adjacent to the third electronic device, and the second fan-out segment comprises a third outermost segment adjacent to the second outermost segment, the third outermost segment having a slope sign which is same as the first slope sign, and wherein the second fan-out segment further comprises a fourth outermost segment spaced from the third outermost segment further from the second outermost segment, the fourth outermost segment having a slope sign which is also same as the first slope sign.

Accordingly, the present invention provides a method for use in an electronic module comprising a first electronic device, a second electronic device and a third electronic device, wherein the first electronic device is electrically connected to the third electronic device via a first conductor pattern, the first conductor pattern comprising a first fan-out section, and the second electronic device is electrically connected to the third electronic device via a second conductor pattern, the second conductor pattern comprising a second fan-out section, wherein the first conductor pattern has a first side (left) and an opposing second side (right) and the second conductor pattern has first side (left) and an opposing second side (right) adjacent to the first side (left) of the first conductor pattern, and wherein the first fan-out section comprises a first outermost fan-out segment on the first side and a second outermost fan-out segment on the second side, the first outermost fan-out segment has a slope with a first slope sign (positive) and the second outermost fan-out segment has a slope with a different second slope sign (negative). The method comprises:

arranging the second fan-out section to comprise a third outermost fan-out segment on the second side (right) of the second conductor pattern such that a slope of the third outermost fan-out segment has the same slope sign as the first slope sign (positive); and

arranging the second fan-out section to comprise a fourth outermost fan-out segment on the first side (left) of the second conductor pattern such that a slope of the fourth outermost fan-out segment also has the same slope sign as the first slope sign (positive), wherein

the first fan-out section has a narrower end adjacent to the first electronic device and a broader end adjacent to the third electronic device, and

the second fan-out section has a narrower end adjacent to the second electronic device and a broader end adjacent the third electronic device.

The present invention is also concerned with an electrical connector, which comprises:

a first conductor pattern arranged for electrically connecting a first electronic device to a third electronic device, the first conductor pattern having a first side and an opposing second side, wherein the first conductor pattern comprises a first fan-out segment having a narrower end adjacent to the first electronic device and a broader end adjacent to the third electronic device, and the first fan-out segment comprises a first outermost segment on the first side and a second outermost segment on the second side, and wherein the first outermost segment has a first slope sign and the second outermost segment has second slope sign opposite to the first slope sign; and

a second conductor pattern arranged for electrically connecting a second electronic device to the third electronic device, wherein the second conductor pattern has a first side and an opposing second side, the second side of the second conductor pattern adjacent to the first side of the first conductor pattern, and wherein the second conductor pattern comprises a second fan-out segment having a narrower end adjacent to the second electronic device and a broader end adjacent to the third electronic device, and the second fan-out segment comprises a third outermost segment adjacent to the second outermost segment, the third outermost segment having a slope sign which is same as the first slope sign, and wherein the second fan-out segment further comprises a fourth outermost segment spaced from the third outermost segment further from the second outermost segment, the fourth outermost segment having a slope sign which is also same as the first slope sign.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in an electronic module comprising a first electronic device, a second electronic device and a third electronic device, wherein the first electronic device is electrically connected to the third electronic device via a first conductor pattern, the first conductor pattern comprising a first fan-out section, and the second electronic device is electrically connected to the third electronic device via a second conductor pattern, the second conductor pattern comprising a second fan-out section, wherein the first conductor pattern has a first side and an opposing second side and the second conductor pattern has first side and an opposing second side adjacent to the first side of the first conductor pattern, and wherein the first fan-out section comprises a first outermost fan-out segment on the first side and a second outermost fan-out segment on the second side, the first outermost fan-out segment has a slope with a first slope sign and the second outermost fan-out segment has a slope with a different second slope sign, said method comprising:
arranging the second fan-out section to comprise a third outermost fan-out segment on the second side of the second conductor pattern such that a slope of the third outermost fan-out segment has the same slope sign as the first slope sign; and
arranging the second fan-out section to comprise a fourth outermost fan-out segment on the first side of the second conductor pattern such that a slope of the fourth outermost fan-out segment also has the same slope sign as the first slope sign, wherein
the first fan-out section has a narrower end adjacent to the first electronic device and a broader end adjacent to the third electronic device, and
the second fan-out section has a narrower end adjacent to the second electronic device and a broader end adjacent the third electronic device.

2. The method of claim 1, wherein the slope of the third outermost fan-out section is equal to the slope of the first outermost fan-out segment.

3. The method of claim 1, wherein the slope of the third outermost fan-out section is smaller than the slope of the first outermost fan-out segment.

4. The method of claim 1, wherein the slope of the third outermost fan-out section is greater than the slope of the first outermost fan-out segment.

5. The method of claim 1, wherein the electronic module further comprises a fourth electronic device electrically connected to the third electronic device via a third conductor pattern adjacent to the second side of the first conductor pattern, said method further comprising:
arranging the third conductor pattern to comprise a third fan-out section, the third fan-out section comprising a fifth outermost fan-out segment adjacent to the second outermost fan-out segment, wherein the fifth outermost fan-out segment has a slope with a slope sign which is same as the second slope sign; and
arranging the third fan-out section to comprise a sixth outermost fan-out segment spaced from the fifth fan-out segment further away from the second outermost fan-out segment, wherein the sixth outermost fan-out segment has a slope with a slope sign which is also same as the second slope sign, wherein the third fan-out segment has a narrower end adjacent to the fourth electronic device and a broader end adjacent to the third electronic device.

6. An electrical connector, comprising:
a first conductor pattern arranged for electrically connecting a first electronic device to a third electronic device, the first conductor pattern having a first side and an opposing second side, wherein the first conductor pattern comprises a first fan-out segment having a narrower end adjacent to the first electronic device and a broader end adjacent to the third electronic device, and the first fan-out segment comprises a first outermost segment on the first side and a second outermost segment on the second side, and wherein the first outermost segment has a first slope sign and the second outermost segment has second slope sign opposite to the first slope sign; and
a second conductor pattern arranged for electrically connecting a second electronic device to the third electronic device, wherein the second conductor pattern has a first side and an opposing second side, the second side of the second conductor pattern adjacent to the first side of the first conductor pattern, and wherein the second conductor pattern comprises a second fan-out segment having a narrower end adjacent to the second electronic device and a broader end adjacent to the third electronic device, and the second fan-out segment comprises a third outermost segment adjacent to the second outermost segment, the third outermost segment having a slope sign which is same as the first slope sign, and wherein the second fan-out segment further comprises a fourth outermost segment spaced from the third outermost segment further from the second outermost segment, the fourth outermost segment having a slope sign which is also same as the first slope sign.

7. The electrical connector of claim 6, wherein the slope of the third outermost fan-out section is equal to the slope of the first outermost fan-out segment.

8. The electrical connector of claim 6, wherein the slope of the third outermost fan-out section is smaller than the slope of the first outermost fan-out segment.

9. The electrical connector of claim 6, wherein the slope of the third outermost fan-out section is greater than the slope of the first outermost fan-out segment.

10. An electronic module comprising:
a first electronic device;
a second electronic device;
a third electronic device;
a first conductor pattern arranged for electrically connecting a first electronic device to a third electronic device, the first conductor pattern having a first side and an opposing second side, wherein the first conductor pattern comprises a first fan-out segment having a narrower end adjacent to the first electronic device and a broader end adjacent to the third electronic device, and the first fan-out segment comprises a first outermost segment on the first side and a second outermost segment on the second side, and wherein the first outermost segment has a first slope sign and the second outermost segment has second slope sign opposite to the first slope sign; and
a second conductor pattern arranged for electrically connecting a second electronic device to the third electronic device, wherein the second conductor pattern has a first side and an opposing second side, the second side of the second conductor pattern adjacent to the first side of the first conductor pattern, and wherein the second conductor pattern comprises a second fan-out segment having a narrower end adjacent to the second electronic device and a broader end adjacent to the third electronic device, and the second fan-out segment comprises a third outermost segment adjacent to the second outermost segment, the third outermost segment having a slope sign which is same as the first slope sign, and wherein the second fan-out segment further comprises a fourth outermost segment spaced from the third outermost segment further from the second outermost segment, the fourth outermost segment having a slope sign which is also same as the first slope sign.

11. The electronic module of claim 10, wherein the slope of the third outermost fan-out section is equal to the slope of the first outermost fan-out segment.

12. The electronic module of claim 10, wherein the slope of the third outermost fan-out section is smaller than the slope of the first outermost fan-out segment.

13. The electronic module of claim 10, wherein the slope of the third outermost fan-out section is greater than the slope of the first outermost fan-out segment.

14. The electronic module of claim 10, further comprises:
a fourth electronic device electrically connected to the third electronic device via a third conductor pattern adjacent to the second side of the first conductor pattern, wherein
the third conductor pattern comprises a third fan-out section, the third fan-out section comprising a fifth outermost fan-out segment adjacent to the second outermost fan-out segment, wherein the fifth outermost fan-out segment has a slope with a slope sign which is same as the second slope sign; and wherein the third fan-out section comprises a sixth outermost fan-out segment spaced from the fifth fan-out segment further away from the second outermost fan-out segment, wherein the sixth outermost fan-out segment has a slope with a slope sign which is also same as the second slope sign, wherein the third fan-out segment has a narrower end adjacent to the fourth electronic device and a broader end adjacent to the third electronic device.

15. The electronic module of claim 10, wherein the first electronic device comprises a first driver circuit; the second electronic device comprises a second drive circuit; and the third electronic device comprises a display area.
